(19) United States
(12) Patent Application Publication
(10) Pub. No.: US 2008/0215984 A1
(43) Pub. Date: Sep. 4, 2008

(54) STORYSHARE AUTOMATION

(76) Inventors: Joseph Anthony Manico, Rochester, NY (US); Timothy John Whitcher, Rochester, NY (US); John Robert McCoy, Webster, NY (US); Thiagarajah Arujunan, Penfield, NY (US)

Correspondence Address: Frank Pincelli;Patent Legal Staff, Eastman Kodak Company, 343 State Street, Rochester, NY, 14650-2201, US

(21) Appl. No.: 11/958,894

(22) Filed: Dec. 18, 2007

Related U.S. Application Data
(60) Provisional application No. 60/870,976, filed on Dec. 20, 2006.

(51) Int. Cl. G06F 3/00

(52) U.S. Cl. 715/730

(57) ABSTRACT

A method and system simplifies the creation process of a multimedia story for a user. It does this by using input and/or derived metadata, by providing constraints on the usability of assets, by automatically suggesting a theme for a story, and identifying appropriate assets and effects to be included in a story, which assets and effects are owned by the user or a third party.

### CROSS-REFERENCES TO RELATED APPLICATIONS

This application claims priority under 35 U.S.C. § 119(e) to U.S. Provisional Application No. 60/870,976, filed on Dec. 20, 2006, entitled: “STORYSHARE AUTOMATION”.

U.S. patent application Ser. No. 11/______, entitled: “AUTOMATED PRODUCTION OF MULTIPLE OUTPUT PRODUCTS”, filed concurrently herewith, is assigned to the same assignee hereof, Eastman Kodak Company, and contains subject matter related, in certain respect, to the subject matter of the present application. The above-identified patent applications are incorporated herein by reference.

### FIELD OF THE INVENTION

The present invention relates to the architecture, methods, and software for automatically creating storyshare products. Specifically, the present invention relates to simplifying the creation process for multimedia slideshows, collages, movies, photobooks, and other image products.

### BACKGROUND OF THE INVENTION

Digital assets typically include still images, videos, and music files, which are created and downloaded to personal computer (PC) storage for personal enjoyment. Typically, these digital assets are accessed when desired for viewing, listening or playing.

Many multimedia applications for the consumer focus on a single output type, such as video, video on CD/DVD, or print. The process for creating the output in these applications is predominantly manual and often time consuming. It is left up to the user to choose what assets to use, what output to create, how to arrange the assets, how to apply any edits to the assets, and what affects to apply to an asset. In addition, choices made for one output type are not maintained for application to an alternative output choice. Example applications include video editing programs, programs for creating DVDs, calendars, greeting cards, etc.

There are some programs available that have introduced a level of automation. In general, they still require the user to select the assets. In some cases they provide additional input such as text, and then make a selection from a limited set of choices that dictates how effects and transitions will be applied to those assets. The application of those effects is fixed, random, or generically applied, and typically are not based on attributes of the image itself.

The present invention provides a solution to the shortcomings of the prior art described above by making available a computer application, which intelligently derives information about the content of digital assets in order to guide the application of transitions, effects, and templates, including incorporating third party content, provided on the computer or available over a network, toward the automatic creation of a desired output from a set of digital assets as input.

### SUMMARY OF THE INVENTION

One preferred embodiment of the present invention pertains to a computer-implemented method for automatically selecting multimedia assets stored on a computer system. The method utilizes input metadata associated with the assets and generates derived metadata therefrom. The assets are then ranked based on the assets' input metadata and derived metadata and a subset of the assets are automatically selected based on the ranking. Another preferred embodiment includes storing user profile information such as user preferences and the step of ranking includes the user profile information. Another preferred embodiment of the invention includes using a theme lookup table that includes a plurality of themes having various thematic attributes and comparing the input and derived metadata with those attributes to identify themes having substantial similarity with the input and derived metadata. The attributes can be related to events or subjects of interest such as birthdays, anniversaries, vacations, holidays, family, or sports. Typically, the assets are digital assets comprised of pictures, still images, text, graphics, music, video, audio, multimedia presentation, or descriptor files.

Another preferred embodiment of the invention includes the use of programmable effects, such as zooming or panning, applied to the assets governed by a rules database for constraining application of the effects to those assets that are best showcased by the effects. Themes and effects can be designed by the user or by third parties. Third party themes and effects include dynamic auto-scaling image templates, automatic image layout algorithms, video scene transitions, scrolling titles, graphics, text, poetry, audio, music, songs, digital motion and still images of celebrities, popular figures, or cartoon characters. The assets are assembled into a storyshare descriptor file based on selected themes, the assets, and on the rules database. The file can be saved on a portable storage device or transmitted to other computer systems. Each descriptor file can be rendered on different output media and formats.

Another preferred embodiment of the invention is a computer system having access to stored multimedia assets and a component for reading metadata associated with the assets and for generating derived metadata. The computer system also has access to a theme descriptor file that includes effects applicable to the assets and thematic templates for presenting the assets in a preferred output format. The theme descriptor file comprises data selected from location information, background information, special effects, transitions, or music. A rules database accessible by the computer system comprises conditions for limiting application of effects to those assets that meet the conditions of the rules database. A tool accessible by the computer system is capable of assembling the assets into a storyshare descriptor file based on a selected output format and on the conditions of the rules database. The multimedia assets include digital assets selected from pictures, still images, text, graphics, music, video, audio, multimedia presentation, and descriptor files.

This invention provides for methods, system and software for composing stories, which use a rules database for constraining random usability of assets and effects within a story.

Another aspect of this invention provides methods, system and software for composing stories where a metadata database is constructed comprising input metadata, derived metadata, and metadata relationships. The metadata database is used to suggest themes for a story.

Another aspect of this invention provides methods, system and software for identifying appropriate assets and effects based on the metadata database to be used within a story. The assets and effects may be owned by the user or by a third party. They may be available on a user's computer system during story creation or they may be accessed remotely over a network.

In another aspect of the invention there is provided a system, method, and software for producing various output products from a storyshare descriptor file, output descriptor files and presentation rules.

Other embodiments that are contemplated by the present invention include computer readable media and program storage devices tangibly embodying or carrying a program of instructions readable by machine or a processor, for having the machine or computer processor execute instructions or data structures stored thereon. Such computer readable media can be any available media, which can be accessed by a general purpose or special purpose computer. Such computer-readable media can comprise physical computer-readable media such as RAM, ROM, EEPROM, CD-ROM, DVD, or other optical disk storage, magnetic disk storage or other magnetic storage devices, for example. Any other media, which can be used to carry or store software programs which can be accessed by a general purpose or special purpose computer are considered within the scope of the present invention.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications. The figures below are not intended to be drawn to any precise scale with respect to size, angular relationship, or relative position.

### BRIEF DESCRIPTION OF THE DRAWINGS

FIG. 1 is a block diagram of a computer system capable of practicing various embodiments of the present invention;

FIG. 2 is diagrammatic representation of the architecture of a system made in accordance with the present invention for composing stories;

FIG. 3 is a flow chart of the operation of a composer module made in accordance with the present invention;

FIG. 4 is a flow chart of the operation of a preview module made in accordance with the present invention;

FIG. 5 is a flow chart of the operation of a render module made in accordance with the present invention;

FIG. 6 is a list of extracted metadata tags obtained from acquisition and utilization systems in accordance with the present invention;

FIG. 7 is a list of derived metadata tags obtained from analysis of asset content and existing extracted metadata tags in accordance with the present invention;

FIGS. 8A-8D is a listing of a sample storyshare descriptor file illustrating the relationship between the asset duration impacting two different outputs in accordance with the present invention;

FIG. 9 is an illustrative slideshow representation made in accordance with the present invention; and

FIG. 10 is an illustrative collage representation made in accordance with the present invention.

### DETAILED DESCRIPTION OF THE INVENTION

An asset is a digital file that consists of a picture, a still image, text, graphics, music, a movie, video, audio, multimedia presentation, or a descriptor file. Several standard formats exist for each type of asset. The storyshare system described herein is about creating intelligent, compelling stories easily in a sharable format and delivering a consistently optimum playback experience across numerous imaging systems. Storyshare allows users to create, play and share stories easily. Stories can include pictures, videos and/or audio. Users can share their stories using imaging services, which will handle the formatting and delivery of content for recipients. Recipients can then easily request output from the shared stories in the form of prints, DVDs, or custom output such as a collage, a poster, a picture book, etc.

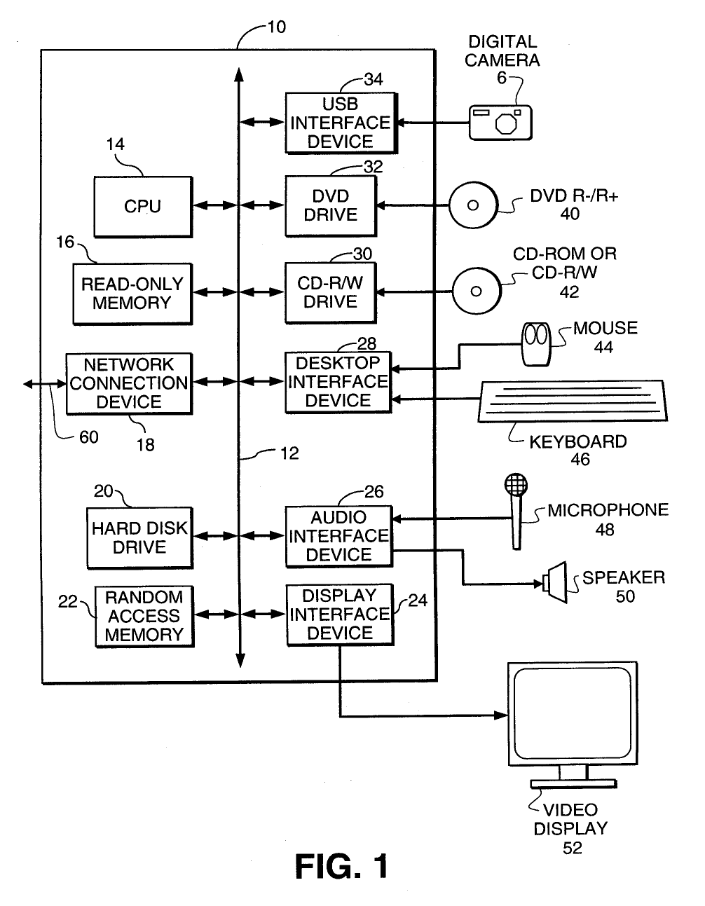

As shown in FIG. 1, a system for practicing the present invention includes a computer system 10. The computer system 10 includes a CPU 14, which communicates with other devices over a bus 12. The CPU 14 executes software stored on a hard disk drive 20, for example. A video display device 52 is coupled to the CPU 14 via a display interface device 24. The mouse 44 and keyboard 46 are coupled to the CPU 14 via a desktop interface device 28. The computer system 10 also contains a CD-R/W drive 30 to read various CD media and write to CD-R or CD-RW writable media 42. A DVD drive 32 is also included to read from and write to DVD disks 40. An audio interface device 26 connected to bus 12 permits audio data from, for example, a digital sound file stored on hard disk drive 20, to be converted to analog audio signals suitable for speaker 50. The audio interface device 26 also converts analog audio signals from microphone 48 into digital data suitable for storage in, for example, the hard disk drive 20. In addition, the computer system 10 is connected to an external network 60 via a network connection device 18. A digital camera 6 can be connected to the home computer 10 through, for example, the USB interface device 34 to transfer still images, audio/video, and sound files from the camera to the hard disk drive 20 and vice-versa. The USB interface can be used to connect USB compatible removable storage devices to the computer system. A collection of digital multimedia or single-media objects (digital images) can reside exclusively on the hard disk drive 20, compact disk 42, or at a remote storage device such as a web server accessible via the network 60. The collection can be distributed across any or all of these as well.

It will be understood that these digital multimedia objects can be digital still images, such as those produced by digital cameras, audio data, such as digitized music or voice files in any of various formats such as “WAV” or “MP3” audio file formats, or they can be digital video segments with or without sound, such as MPEG-1 or MPEG-4 video. Digital multimedia objects also include files produced by graphics software. A database of digital multimedia objects can comprise only one type of object or any combination.

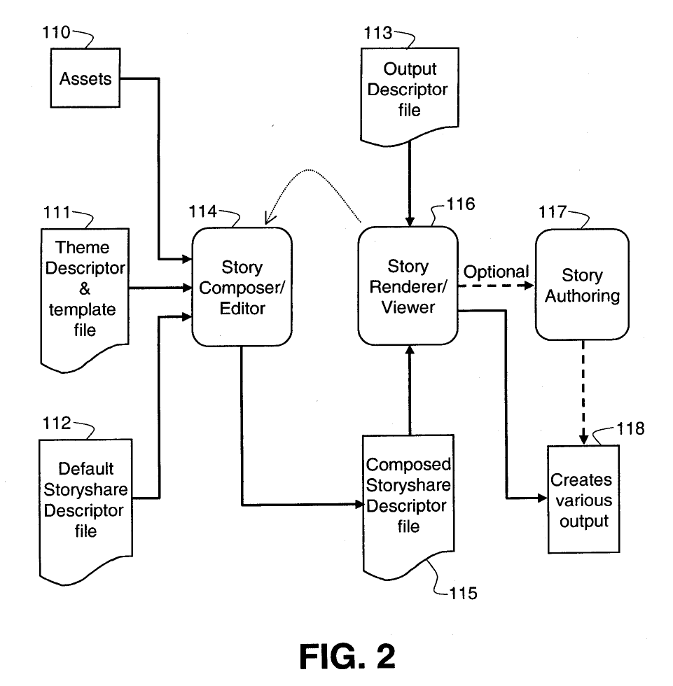

With minimal user input, the storyshare system can intelligently create stories automatically. The storyshare architecture and workflow of a system made in accordance with the present invention is concisely illustrated by FIG. 2 and contains the following elements:
Assets 110 can be stored on a computer, computer accessible storage, or over a network.
Storyshare descriptor file 112.
Composed storyshare descriptor file 115.
Theme descriptor file 111.
Output descriptor files 113.
Story composer/editor 114.
Story renderer/viewer 116.
Story authoring component 117.

In addition to the above, there are theme style sheets, which are the background and foreground assets for the themes. A foreground asset is an image that can be superimposed on another image. A background image is an image that provides a background pattern, such as a border or a location, to a subject of a digital photograph. Multiple layers of foreground and background assets can be added to an image for creating a unique product.

The initial story descriptor file 112 can be a default XML file, which can be used by any system optionally to provide any default information. Once this file is fully populated by the composer 114 this file will then become a composed story descriptor file 115. In its default version it includes basic information for composing a story, for example, a simple slideshow format can be defined that displays one line of text, blank areas may be reserved for some number of images, a display duration for each is defined, and background music can be selected.

The composed story descriptor file provides necessary information required to describe a compelling story. A composed story descriptor file will contain, as described below, the asset information, theme information, effects, transitions, metadata and all other required information in order to construct a complete and compelling story. In some ways it is similar to a story board and can be a default descriptor, as described above, minimally populated with selected assets or, for example, it may include a large number of user or third party assets including multiple effects and transitions.

Therefore once this composed descriptor file 115 is created (which represents a story), then this file along with the assets related to the story can be stored in a portable storage device or transmitted to, and used in, any imaging system which has the rendering component 116 to create a storyshare output product. This allows systems to compose a story, persist the information via this composed story descriptor file and then create the rendered storyshare output file (slideshow, movie, etc.) at a later time on a different computer or to a different output.

The theme descriptor file 111 is another XML file, for example, which provides necessary theme information, such as artistic representation. This will include:
Location of the theme such as in a computer system or on a network such as the internet.
Background/foreground information.
Special effects, transitions that are specific to a theme, such as holiday theme or personally significant.
Music file related to a theme.

The theme descriptor file is, for example, in an XML file format and points to an image template file, such as a JPG file that provides one or more spaces designated to display an asset 110 selected from an asset collection. Such a template may show a text message saying “Happy Birthday,” for example, in a birthday template.

The composer 114 used to develop a story will use theme descriptor files 111 containing the above information. It is a module that takes input from the three earlier components and can optionally apply automatic image selection algorithms to compose the story descriptor file 115. The user could select the theme or the theme could be algorithmically selected by the content of the assets provided. The composer 114 will utilize the theme descriptor file 111 when building the composed storyshare descriptor file 115.

The story composer 114 is a software component, which intelligently creates a composed story descriptor file, given the following input:
Asset location and asset related information (metadata). The user selects assets 110 or they may be automatically selected from an analysis of the associated metadata.
Theme descriptor file 111.
User input related to effects, transition and image organization. Generally, the theme descriptor file will contain most of this information, but the user will have the option of editing some of this information.

With this input information, the composer component 114 will lay out the necessary information to compose the complete story in the composed story descriptor file, which contains all the required information needed by the renderer. Any edits done by the user through the composer will be reflected on the story descriptor file 115.

Given the input the composer will do the following:
Intelligent organization of assets such as grouping or establishing a chronology.
Apply appropriate effects, transitions, etc., based on the theme selected.
Analyze asset and read necessary information required to create a compelling story. This requires specification information with regard to assets that can be used to determine whether effects will be feasible on particular assets.

The output descriptor file 113 is an XML file, for example, which contains information on what output will be produced and the information required to create the output. This file will contain the constrains based on:
Device capabilities of an output device.
Hard copy output formats.
Output file formats (MPEG, Flash, MOV, MPV).
Rendering rules used, such as described below, to facilitate the rendering of stories when the output modality requires information that is not contained in the story descriptor file (because the output device is not known—the descriptor can be reused on another device).
Descriptor translation information such as XSL Transformation language (XSLT programs used to modify the story descriptor file so it contains no scalable information but only information specific to the output modality.

Output descriptor file 113, is used by the renderer 116, to determine available output format.

The story renderer 116 is a configurable component comprised of optional plug-ins that corresponds to the different output format supported by the rendering system. It formats the storyshare descriptor file 115 depending on the selected output format for the storyshare product. The format may be modified if the output is intended to be viewed on a small cell phone, a large screen device, or print formats such as photobooks, for example. The renderer then determines required resolutions, etc. needed for the assets based on output format constraints, etc. In operation, this component will read the composed storyshare descriptor file 115 created by the composer 114, and act on it by processing the story and creating the required output 18 such as in a DVD or other hardcopy format (slideshow, movie, custom output, etc.). The renderer 116 interprets the story descriptor file 115 elements, and depending on the output type selected, the renderer will create the story in the format required by the output system. For example the renderer could read the composed storyshare descriptor file 115 and create a MPEG-2 slideshow, based on all the information described in the composed story descriptor file 115. The renderer 116 will perform the following functions:
Read the composed story descriptor file 115 and interpret it correctly.
Translate the interpretation and call the appropriate plug-in to do the actual encoding/transcoding.
Create the requested rendered output format.

This component takes the created story and authors it by creating menus, titles, credits, and chapters appropriately, depending on the required output.

The authoring component 117 creates a consistent playback menu experience across various imaging systems. Optionally, this component will contain the recording capability. It is also comprised of optional plug-in modules for creating particular outputs, such as slideshow using software implementing MPEG-2 or a photobook software for creating a photobook, or a calendar plug-in for creating a calendar, for example. Particular outputs in XML format may be capable of being directly fed to devices that interpret XML and so would not require special plug-ins.

After a particular story is described in the composed story descriptor file 115, this file can be reused to create various output formats of that particular story. This allows the story to be composed by, or on, one computer system and persist via the descriptor file. The composed story descriptor file can be stored on any system, or portable, storage device and then reused to create various outputs on different imaging systems.

In other embodiments of the present invention the story descriptor file 115 does not contain presentation information but rather it references an identifier for a particular presentation that has been stored in the form of a template. In these embodiments, a template library, such as described in reference to theme descriptor file 111, would be embedded in the composer 114 and also in the renderer 116. The story descriptor file would then point to the template files but not include them as a part of the descriptor file itself. In this way the complete story would not be exposed to a third party who may be an unintended recipient of the story descriptor file.

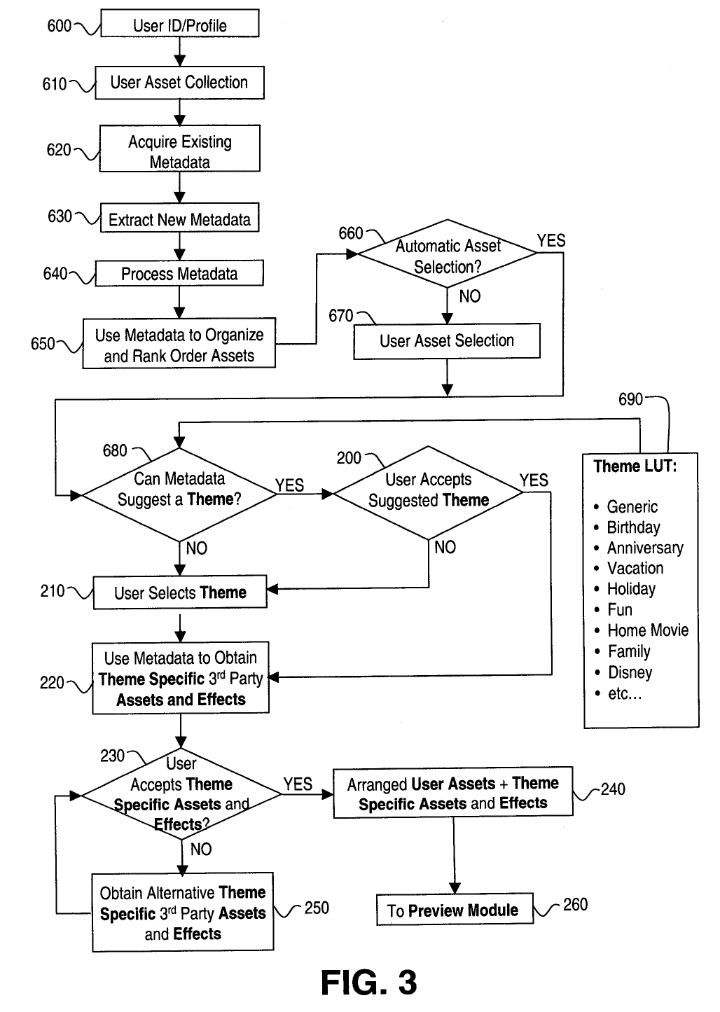

As described in a preferred embodiment, the three main modules within the storyshare architecture, i.e. the composer module 114, the preview module (not shown in FIG. 2), and the render module 116, are illustrated in more detail in FIGS. 3, 4, and 5, respectively, and are described in more detail as follows. Referring to FIG. 3, an operational flow chart of the composer module of the invention is illustrated. In step 600 the user begins the process by identifying herself to the system. This can take the form user name and password, a biometric ID, or by selecting a preexisting account. By providing an ID the system can incorporate any user's preferences and profile information, previous usage patterns, personal information such as existing personal and familial relationships and significant dates and occasions. This also can be used to provide access to a user's address book, phone, and/or email list, which may be required to facilitate sharing of the finished product to an intended recipient. The user ID can also be used to provide access to the user's asset collection as shown in step 610. A user's asset collection can include personally and commercially generated third party content including: digital still images, text, graphics, video clips, sound, music, poetry, and the like. At step 620 the system reads and records existing metadata, referred to herein as input metadata, associated with each of the asset files such as time/date stamps, exposure information, video clip duration, GPS location, image orientation, and file names. At step 630 a series of asset analysis techniques such as eye/face identification/recognition, object identification/recognition, text recognition, voice to text, indoor/outdoor determination, scene illuminant, and subject classification algorithms are used to provide additional asset derived metadata. Some of the various image analysis and classification algorithms are described in several commonly owned patents and patent applications. For example, temporal event clustering of image assets is generated by automatically sorting, segmenting, and clustering an unorganized set of media assets into separate temporal events and sub-events, as described in detail in commonly assigned U.S. Pat. No. 6,606,411 entitled: “A Method For Automatically Classifying Images Into Events,” issued on Aug. 12, 2003; and commonly assigned U.S. Pat. No. 6,351,556, entitled: “A Method For Automatically Comparing Content of Images for Classification Into Events”, issued on Feb. 26, 2002. Content-Based Image Retrieval (CBIR) retrieves images from a database that are similar to an example (or query) image, as described in detail in commonly assigned U.S. Pat. No. 6,480,840, entitled: “Method And Computer Program Product For Subjective Image Content Similarity-Based Retrieval”, issued on Nov. 12, 2002. Images may be judged to be similar based upon many different metrics, for example similarity by color, texture, or other recognizable content such as faces. This concept can be extended to portions of images or Regions Of Interest (ROI). The query can be either a whole image or a portion (ROI) of the image. The images retrieved can be matched either as whole images, or each image can be searched for a corresponding region similar to the query. In the context of the current invention, CBIR may be used to automatically select or rank assets that are similar to other assets or to a theme. For example, “Valentine's Day” themes might need to find images with a predominance of the color red, or autumn colors for a “Halloween” theme. Scene classifiers identify or classify a scene into one or more scene types (e.g., beach, indoor, etc.) or one or more activities (e.g., running, etc.). Example scene classification types and details of their operation are described in U.S. Pat. No. 6,282,317, entitled: “Method For Automatic Determination Of Main Subjects In Photographic Images”; U.S. Pat. No. 6,697,502, entitled: “Image Processing Method For Detecting Human Figures In A Digital Image Assets”; U.S. Pat. No. 6,504,951, entitled: “Method For Detecting Sky In Images”; U.S. Publication No. US 2005/0105776 A1, entitled: “Method For Semantic Scene Classification Using Camera Metadata And Content-Based Cues”; U.S. Publication No. US 2005/0105775 A1, entitled: “Method Of Using Temporal Context For Image Classification”; and U.S. Publication No. US 2004/003746 A1, entitled: “Method For Detecting Objects In Digital Image Assets.” A face detection algorithm can be used to find as many faces as possible in asset collections, and is described in U.S. Pat. No. 7,110,575, entitled: “Method For Locating Faces In Digital Color Images,” issued on Sep. 19, 2006; U.S. Pat. No. 6,940,545, entitled: “Face Detecting Camera And Method,” issued on Sep. 6, 2005; U.S. Publication No. US 2004/0179719 A1, entitled: “Method And System For Face Detection In Digital Image Assets,” (U.S. patent application filed on Mar. 12, 2003). Face recognition is the identification or classification of a face to an example of a person or a label associated with a person based on facial features as described in U.S. patent application Ser. No. 11/559,544, entitled: “User Interface For Face Recognition,” filed on Nov. 14, 2006; U.S. patent application Ser. No. 11/342,053, entitled: “Finding Images With Multiple People Or Objects,” filed on Jan. 27, 2006; and U.S. patent application Ser. No. 11/263,156, entitled: “Determining A Particular Person From A Collection,” filed on Oct. 31, 2005. Face clustering uses data generated from detection and feature extraction algorithms to group faces that appear to be similar. As explained in detail below, this selection may be triggered based on a numeric confidence value. Location-based data as described in U.S. Publication No. US 2006/0126944 A1, entitled: “Variance-Based Event Clustering,” U.S. patent application filed on Nov. 17, 2004, can include cell tower locations, GPS coordinates, and network router locations. A capture device may or may not include metadata archiving with an image or video file; however, these are typically stored with the asset as metadata by the recording device, which captures an image, video or sound. Location-based metadata can be very powerful when used in concert with other attributes for media clustering. For example, the U.S. Geological Survey's Board on Geographical Names maintains the Geographic Names Information System, which provides a means to map latitude and longitude coordinates to commonly recognized feature names and types, including types such as church, park or school. Identification or classification of a detected event into a semantic category such as birthday, wedding, etc. is described in detail in U.S. Publication No. US 2007/0008321 A1, entitled: “Identifying Collection Images With Special Events,” U.S. patent application filed on Jul. 11, 2005. Media assets classified as an event can be so associated because of the same location, setting, or activity per a unit of time, and are intended to be related to the subjective intent of the user or group of users. Within each event, media assets can also be clustered into separate groups of relevant content called sub-events. Media in an event are associated with same setting or activity, while media in a sub-event have similar content within an event. An Image Value Index (“IVI”) is defined as a measure of the degree of importance (significance, attractiveness, usefulness, or utility) that an individual user might associate with a particular asset (and can be a stored rating entered by the user as metadata), and is described in detail in U.S. patent application Ser. No. 11/403,686, filed on Apr. 13, 2006, entitled: “Value Index From Incomplete Data,” and in U.S. patent application Ser. No. 11/403,583, filed on Apr. 13, 2006, entitled: “Camera User Input Based Image Value Index”. Automatic IVI algorithms can utilize image features such as sharpness, lighting, and other indications of quality. Camera-related metadata (exposure, time, date), image understanding (skin or face detection and size of skin/face area), or behavioral measures (viewing time, magnification, editing, printing, or sharing) can also be used to calculate an IVI for any particular media asset. The prior art references listed in this paragraph are hereby incorporated by reference in their entirety.

At step 640 the new derived metadata is stored together with the existing metadata in association with a corresponding asset to augment the existing metadata. The new metadata set is used to organize and rank order the user's assets at step 650. The ranking is based on outputs of the analysis and classification algorithms based on relevance or, optionally, an image value index, which provides a quantitative result as described above.

At decision step 660 a subset of the user's assets can be automatically selected based on the combined metadata and user preferences. This selection represents an edited set of assets using rank ordering and quality determining techniques such as image value index. At step 670 the user may optionally choose to override the automatic asset selection and choose to manually select and edit the assets. At decision 680 an analysis of the combined metadata set and selected assets is performed to determine if an appropriate theme can be suggested. A theme in this context is an asset descriptor such as sports, vacation, family, holidays, birthdays, anniversaries, etc. and can be automatically suggested by metadata such as a time/date stamp that coincides with a relative's birthday obtained from the user profile. This is beneficial because of the almost unlimited thematic treatments available today for consumer-generated assets. It is a daunting task for a user to search through this myriad of options to find a theme that conveys the appropriate emotional sentiment and that is compatible with the format and content characteristics of the user's assets. By analyzing the relationship and image content a more specific theme can be suggested. For example, if the face recognition algorithm identifies “Molly” and the user's profile indicates that “Molly” is the user's daughter. The user profile can also contain information that last year at this time the user produced a commemorative DVD of “Molly's 4^{th} Birthday Party”. Dynamic themes can be provided to automatically customize a generic theme such as “Birthday” with additional details. If image templates are used in the theme that can be modified with automatic “fill in the blank” text and graphics this would enable changing “Happy Birthday” to “Happy 5^{th} Birthday Molly” without requiring user intervention. Box 690 is included in step 680 and contains a list of available themes, which can be provided locally via a removable memory device such as a memory card or DVD or via a network connection to a service provider. Third party participants and copyrighted content owners can also provide themes on a pay-per-use type arrangement. The combined input and derived metadata, the analysis and classification algorithm output, and organized asset collection is used to limit the user's choices to themes that are appropriate for the content of the assets and compatible with the asset types. At step 200 the user has the option to accept or reject the suggested theme. If no theme is suggested at step 680 or the user decides to reject the suggested theme at step 200, she is given the option to manually select a theme from a limited list of themes or from the entire available library of available themes at step 210.

A selected theme is used in conjunction with the metadata to acquire theme specific third party assets and effects. At step 220 this additional content and treatments can be provided by a removable memory device or can be accessed via a communication network from a service provider or via pointers to a third party provider. Arrangements between various participants concerning revenue distribution and terms for usage of these properties can be automatically monitored and documented by the system based on usage and popularity. These records can also be used to determine user preferences so that popular theme specific third party assets and effects can be ranked higher or given a higher priority increasing the likelihood of consumer satisfaction. These third party assets and effects include dynamic auto-scaling image templates, automatic image layout algorithms, video scene transitions, scrolling titles, graphics, text, poetry, music, songs, digital motion and still images of celebrities, popular figures, and cartoon characters all designed to be used in conjunction with user generated and/or acquired assets. The theme specific third party assets and effects as a whole are suitable for both hardcopy such as greeting cards, collages, posters, mouse pads, mugs, albums, calendars, and soft copy such as movies, videos, digital slide shows, interactive games, websites, DVDs, and digital cartoons. The selected assets and effects can be presented to the user, for her approval, as set of graphic images, a story board, a descriptive list, or as a multimedia presentation. At decision step 230 the user is given the option to accept or reject the theme specific assets and effects and if she chooses to reject them, the system presents an alternative set of assets and effects for approval or rejection at step 250. Once the user accepts the theme specific third party assets and effects at step 230, they are combined with the organized user assets at step 240 and the preview module is initiated at step 260.

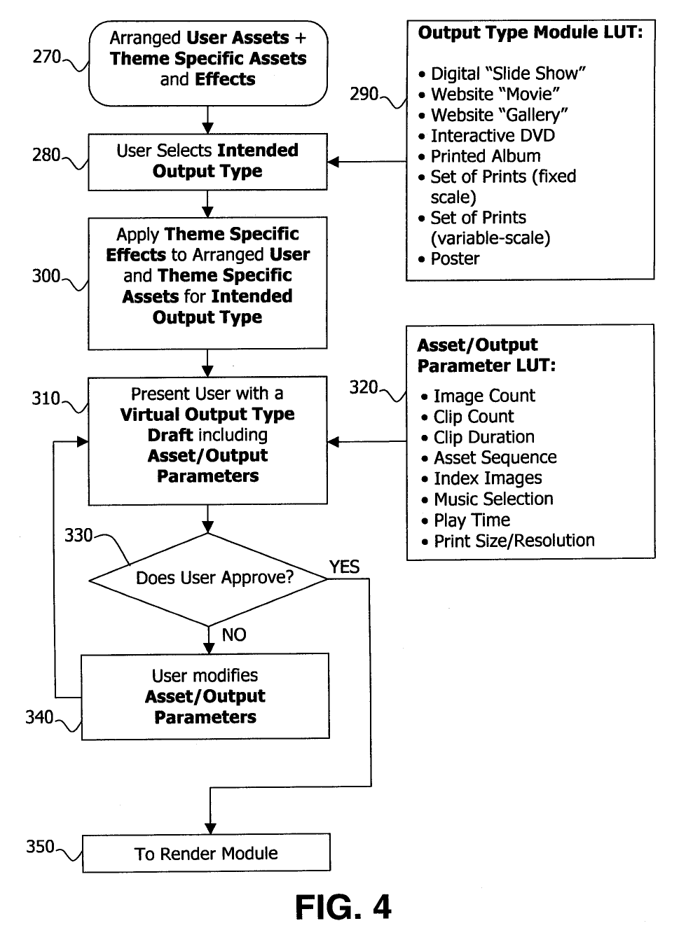

Referring now to FIG. 4, an operational flowchart of the preview module is illustrated. At step 270 the arranged user assets and theme specific assets and effects are made available to the preview module. At step 280 the user selects an intended output type. Output types include various hard and soft copy modalities such as prints, albums, posters, videos, DVDs, digital slideshows, downloadable movies, and websites. Output types can be static as with prints and albums or interactive presentations such as with DVDs and video games. The types are available from a Look-Up Table (LUT) 290, which can be provided to the preview module on removable media or accessed via a communications network. New output types can be provided as they become available and can be provided by third party vendors. An output type contains all of the rules and procedures required to present the user assets and theme specific assets and effects in a form that is compatible with the selected output modality. The output type rules are used to select from the user assets and theme specific assets and effects items that are appropriate for the output modality. For instance, if the song “Happy Birthday” is a designated theme specific asset it would be presented as sheet music or omitted altogether from a hard copy output such as a photo album. If a video, digital slide show, or DVD were selected then the audio content of the song would be selected. Likewise, if face-detection algorithms are used to generate content derived metadata this same information can be used to provide automatically cropped images for hardcopy output applications or dynamic, face centric, zooms, and pans for soft copy applications.

At step 300 the theme specific effects are applied to the arranged user and theme specific assets for the intended output type. At step 310 a virtual output type draft is presented to the user along with asset and output parameters such as provided in LUT 320 which includes output specific parameters such as image counts, video clip count, clip duration, print sizes, photo album page layouts, music selection, and play duration. These details along with the virtual output type draft are presented to the user at step 310. At decision step 330 the user is given the option to accept the virtual output type draft or to modify asset and output parameters. If the user wants to modify the asset/output parameters she proceeds to step 340. One example of how this could be used would be to shorten a downloadable video from a 6-minute total duration to a video with a 5-minute duration. The user could select to manually edit the assets or allow the system to automatically remove and/or shorten the presentation time of assets, speed up transitions, and the like to shorten the length of the video. Once the user is satisfied with the virtual output type draft at decision step 330 it is sent to the render module at step 350.

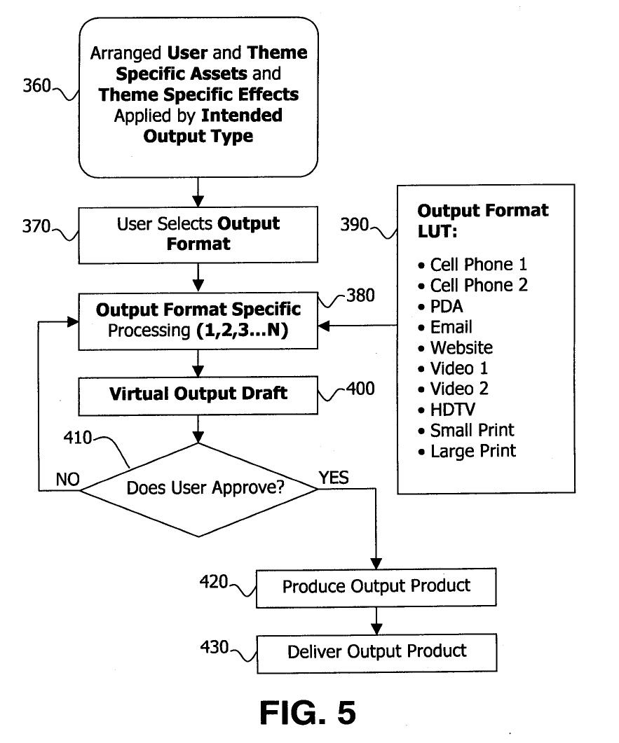

Referring now to FIG. 5 there is illustrated the operational flow chart of the operation of the render module 116. Turning now to step 360 the arranged user assets and theme specific assets and effects applied by intended output type are made available to the render module. At step 370 the user selects an output format from the available look up table shown in step 390. This LUT can be provided via removable memory device or network connection. These output formats include the various digital formats supported by multimedia devices such as personal computers, cellular telephones, server-based websites, or HDTV's. These output formats also support digital formats like JPG and TIFF that are required to produce hard copy output print formats such as loose 4″×6″ prints, bound albums, and posters. At step 380 the user selected output format specific processing is applied to the arranged user and theme specific assets and theme specific effects. At step 400 a virtual output draft is presented to the user and at decision step 410 it can be approved or rejected by the user. If the virtual output draft is rejected the user can select an alternative output format and if the user approves the output product is produced at step 420. The output product can be produced locally as with a home PC and/or printer or produced remotely as with the Kodak Easy Share Gallery™. With remotely produced soft copy type output products they are delivered to the user via a network connection or physically shipped to the user or designated recipient at step 430.

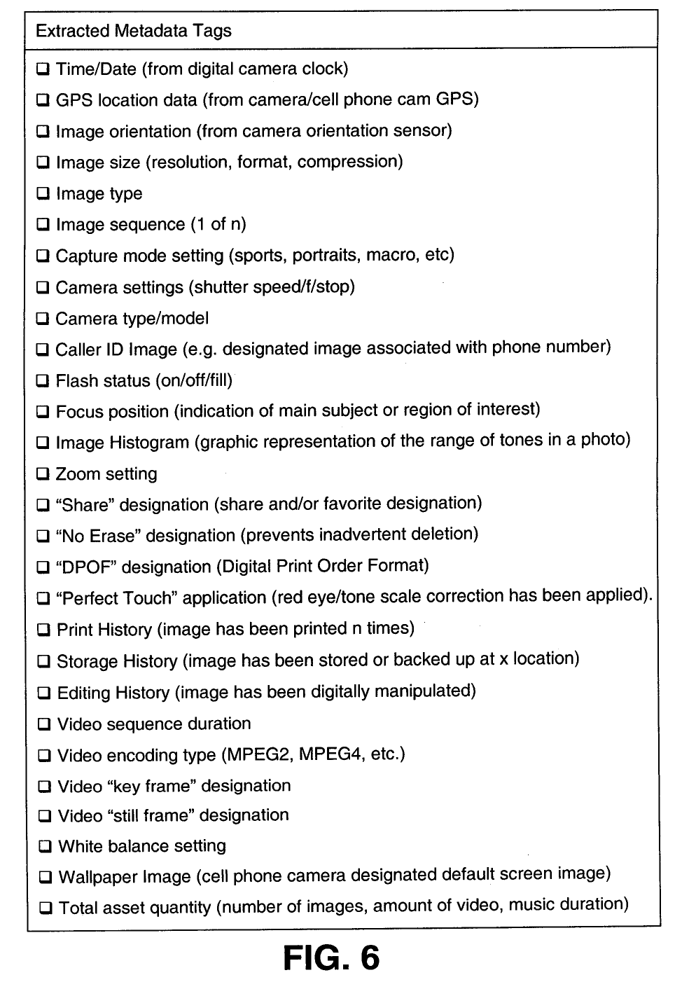

Referring now to FIG. 6, a list of extracted metadata tags obtained from asset acquisition and utilization systems including cameras, cell phone cameras, personal computers, digital picture frames, camera docking systems, imaging appliances, networked displays, and printers. Extracted metadata is synonymous with input metadata and includes information recorded by an imaging device automatically and from user interactions with the device. Standard forms of extracted metadata include: time/date stamps, location information provided by Global Positioning Systems (GPS), nearest cell tower, or cell tower triangulation, camera settings, image and audio histograms, file format information, and any automatic image corrections such as tone scale adjustments and red eye removal. In addition to this automatic device centric information recording, user interactions can also be recorded as metadata and include; “Share”, “Favorite”, or “No-Erase” designation, “Digital Print Order Format (DPOF), user selected “Wallpaper Designation” or “Picture Messaging” for cell phone cameras, user selected “Picture Messaging” recipients via cell phone number or e-mail address, and user selected capture modes such as “Sports”, “Macro/Close-Up”, “Fireworks”, and “Portrait”. Image utilizations devices such as personal computers running Kodak Easy Share™ software or other image management systems and stand alone or connected image printers also provide sources of extracted metadata. This type of information includes print history indicating how many times an image has been printed, storage history indicating when and where an image has been stored or backed-up, and editing history indicating the types and amounts of digital manipulations that have occurred. Extracted metadata is used to provide a context to aid in the acquisition of derived metadata.

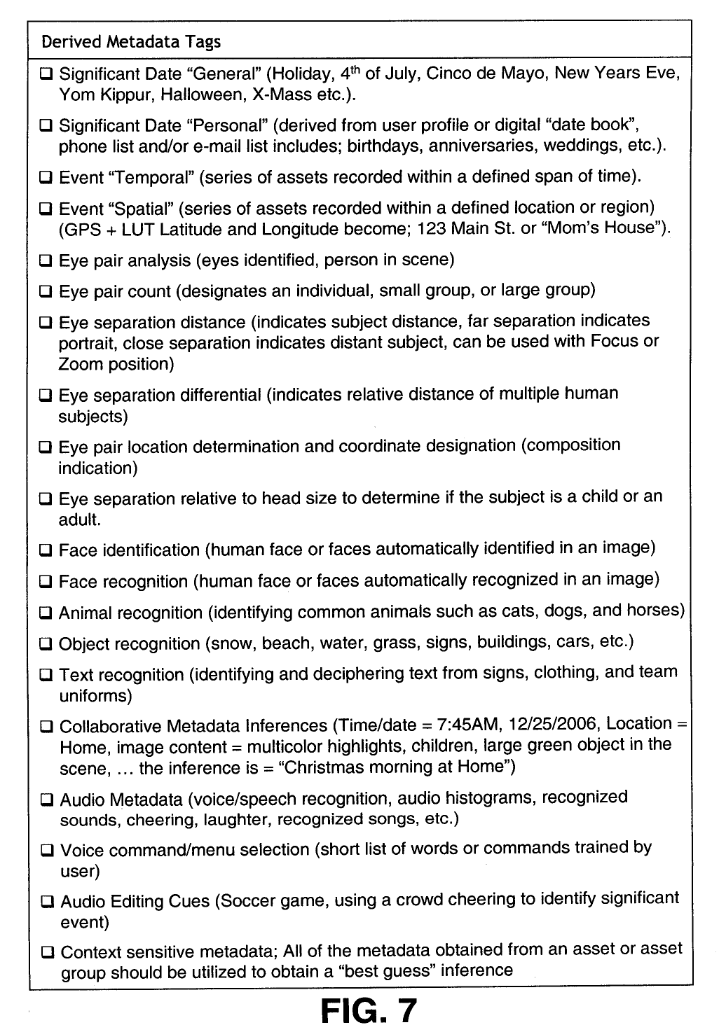

Referring now to FIG. 7, a list of derived metadata tags obtained from analysis of asset content and existing extracted metadata tags. Derived metadata tags can be created by asset acquisition and utilization systems including: cameras, cell phone cameras, personal computers, digital picture frames, camera docking systems, imaging appliances, networked displays, and printers. Derived metadata tags can be created automatically when certain predetermined criteria are met or from direct user interactions. An example of the interaction between extracted metadata and derived metadata is using a camera generated image capture time/date stamp in conjunction with a user's digital calendar. Both systems can be collocated on the same device as with a cell phone camera or can be dispersed between imaging devices such as a camera and personal computer camera docking system. A digital calendar can include significant dates of general interest such as: Cinco de Mayo, Independence Day, Halloween, Christmas, and the like as well as significant dates of personal interest such as; “Mom & Dad's Anniversary”, “Aunt Betty's Birthday”, and “Tommy's Little League Banquet”. Camera generated time/date stamps can be used as queries to check against the digital calendar to determine if any images or other assets were captured on a date of general or personal interest. If matches are made the metadata can be updated to include this new derived information. Further context setting can be established by including other extracted and derived metadata such as location information and location recognition. If, for example, after several weeks of inactivity a series of images and videos are recorded on September 5^{th} at a location that was recognized as “Mom & Dad's House”. In addition the user's digital calendar indicated that September 5^{th} is “Mom & Dad's Anniversary” and several of the images include a picture of a cake with text that reads, “Happy Anniversary Mom & Dad”. Now the combined extracted and derived metadata can automatically provide a very accurate context for the event, “Mom & Dad's Anniversary”. With this context established only relevant theme choices would be made available to the user significantly reducing the workload required to find an appropriate theme. Also labeling, captioning, or blogging, can be assisted or automated since the event type and principle participants are now known to the system.

Another means of context setting is referred to as “event segmentation” as described above. This uses time/date stamps to record usage patterns and when used in conjunction with image histograms it provides a means to automatically group images, videos, and related assets into “events”. This enables a user to organize and navigate large asset collections by event.

The content of image, video, and audio assets can be analyzed using face, object, speech, and text identification and algorithms. The number of faces and relative positions in a scene or sequence of scenes can reveal important details to provide a context for the assets. For example a large number of faces aligned in rows and columns indicates a formal posed context applicable to family reunions, team sports, graduations, and the like. Additional information such as team uniforms with identified logos and text would indicate a “sporting event”, matching caps and gowns would indicate a “graduation”, and assorted clothing may indicate a “family reunion”, and a white gown, matching colored gowns, and men in formal attire would indicate a “Wedding Party”. These indications combined with additional extracted and derived metadata provides an accurate context that enables the system to select appropriate assets, provided relevant themes for the selected assets, and to provide relevant additional assets to the original asset collection.

StoryShare—the Rules within Themes:

Themes are a component of storyshare that enhances the presentation of user assets. A particular story is built upon user provided content, third party content, and how that content is presented. The presentation may be hard or softcopy, still, video, or audio, or a combination or all of these. The theme will influence the selection of third party content and the types of presentation options that a story utilizes. The presentation options include, backgrounds, transitions between visual assets, effects applied to the visual assets, and supplemental audio, video, or still content. If the presentation is softcopy, the theme will also affect the time base, that is, the rate that content is presented.

In a story, the presentation involves content and operations on that content. It is important to note that the operations will be affected by the type of content on which they operate. Not all operations that are included in a particular theme will be appropriate for all content that a particular story includes.

When a story composer determines the presentation of a story, it develops a description of a series of operations upon a given set of content. The theme may contain information that serves as a framework for that series of operations in the story. Comprehensive frameworks are used in “one-button” story composition. Less comprehensive frameworks are used when the user has interactive control of the composition process. The series of operations is commonly known as a template. A template can be considered to be an unpopulated story, that is, the assets are not specified. In all cases, when the assets are assigned to the template, the operations described in the template follow rules when applied to content.

In general, the rules associated with a theme take an asset as an input argument. The rules constrain what operations can be performed on what content during the composition of a story. Additionally, the rules associated with a theme can modify or enhance the series of operations, or template, so that the story may become more complex if assets contain specific metadata.

### Examples of Rules:

1) Not all image files have the same resolution. Therefore not all image files can support the same range for a zoom operation. A rule to limit the zoom operation on a particular asset would be based on some combination of the metadata associated with the asset such as: resolution, subject distance, subject size, or focal length, as an example.

2) The operations used in the composition of a story will be based on the existence of an asset having certain metadata properties or the ability to apply a particular algorithm to that asset. If the existence or applicability condition cannot be met, then the operation cannot be included for that asset. For example, if the composition search property is looking for “tree” and there are no pictures containing trees in the collection, then the picture will not be selected.

Any algorithm that looks for “Christmas tree ornament” pictures cannot be applied subsequently.

3) Some operations require two (or possibly more) assets. Transitions are an example where two assets are required. The description of the series of operations must reference the correct number of assets that a particular operation requires. Additionally, the referenced operations must be of the appropriate type. That is to say a transition cannot occur between an audio asset and a still image. In general, operations are type specific as one cannot zoom in on an audio asset.

4) Depending on the operations used and constraints imposed by the theme, the order of the operations performed on an asset might be constrained. That is the composition process may require a pan operation to precede a zoom operation.

5) Certain themes may prohibit certain operations from being performed. For example, a story might not include video content, but only still images and audio.

6) Certain themes may restrict the presentation time, any particular asset, or asset type may have in a story. In this case the display, show, or play operations would be limited. In the case of audio or video, such a rule will require the composer to do temporal preprocessing before including an asset in a description of the series of operations.

7) It is possible that a theme having a comprehensive framework includes references to operations that do not exist on a particular version of a composer. Therefore it is necessary for the theme to include operation substitution rules. Substitutions particularly apply to transitions. A “wipe” may have several blending effects when transitioning between two assets. A simple sharp edge wipe may be the substitute transition if the more advanced transitions cannot be described by the composer. One should note that the rendering device will also have substitution rules for cases where it cannot render the transition described by the story descriptor. In many cases it may be possible to substitute a null operation for an unsupported operation.

8) The rules of a particular theme may check whether or not an asset contains specific metadata. If a particular asset contains specific metadata, then additional operations can be performed on that asset constrained by the template present in the theme. Therefore, a particular theme may allow for conditional execution of operations on content. This gives the appearance of dynamically altering the story as a function of what assets are associated with a story or, more specifically, what metadata is associated with the assets that are associated with the story.

### Rules for Business Constraints:

Depending on the particular embodiment, a theme may place restrictions on operations depending on the sophistication or price of the composer or the privilege of a user. Rather than assign different sets of themes to different composers, a single theme would constrain the operations permitted in the composition process based on an identifier of composer or user class.

### StoryShare, Additional Applicable Rules:

Presentation rules may be a component of a theme. When a theme is selected, the rules in the theme descriptor become embedded in the story descriptor. Presentation rules may also be embedded in the composer. A story descriptor can reference a large number of renditions that might be derived from a particular primary asset. Including more renditions will lengthen the time needed to compose a story because the renditions must be created and stored somewhere within the system before they can be referenced in the story descriptor. However, the creation of renditions makes rendering of the story more efficient particularly for multimedia playback. Similar to the rule described in theme selection, the number and formats of renditions derived from a primary asset during the composition process will be weighted most heavily by renderings requested and logged in the user's profile, followed by themes selected by the general population.

Rendering rules are a component of output descriptors. When a user selects an output descriptor, those rules help direct the rendering process. A particular story descriptor will reference the primary encoding of a digital asset. In the case of still images, this would be the Original Digital Negative (ODN). The story descriptor will likely reference other renditions of this primary asset. The output descriptor will likely be associated with a particular output device and therefore a rule will exist in the output descriptor to select a particular rendition for rendering.

Theme selection rules are embedded in the composer. User input to the composer and metadata that is present in the user content guides the theme selection process. The metadata associated with a particular collection of user content may lead to the suggestion of several themes. The composer will have access to a database which will indicate which of the suggested themes based on metadata has the highest probability of selection by the user. The rule would weigh most heavily themes that fit the user's profile, followed by themes selected by the general population.

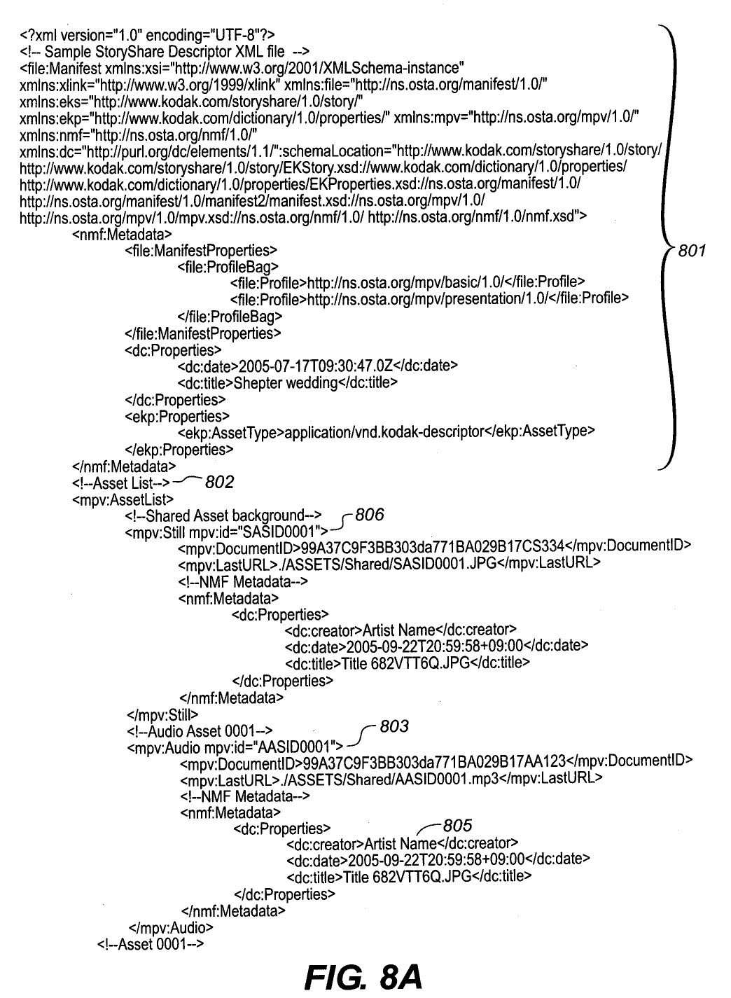

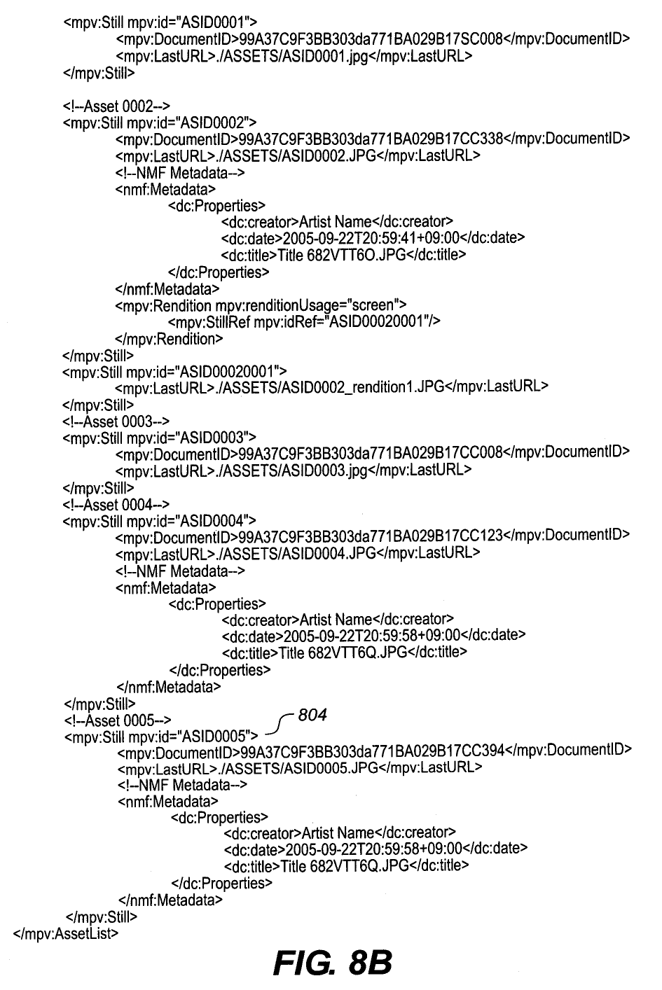

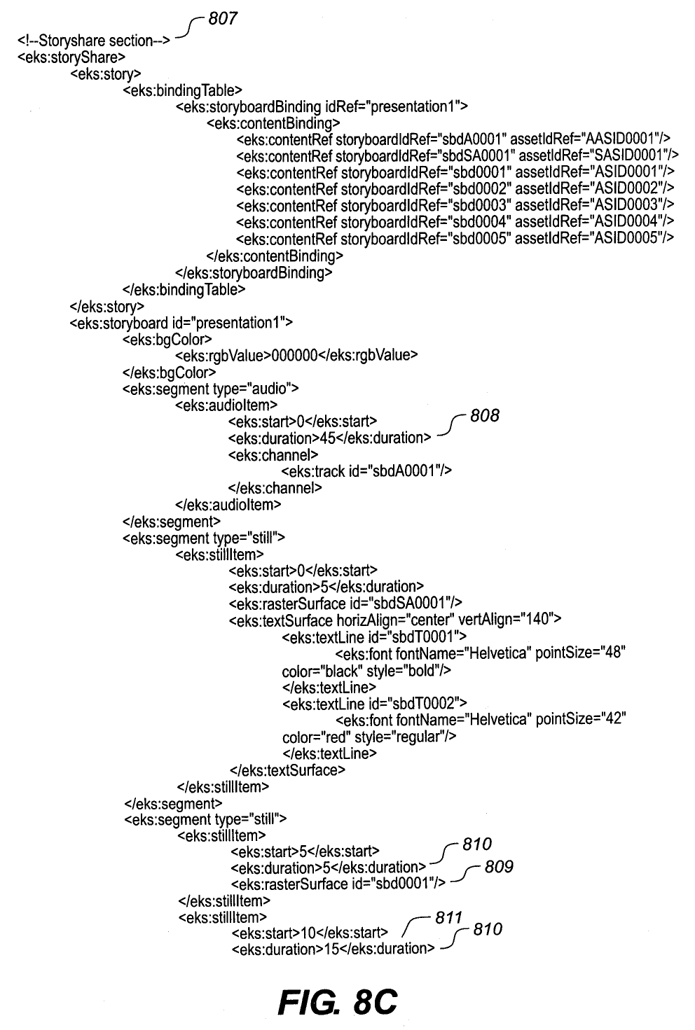

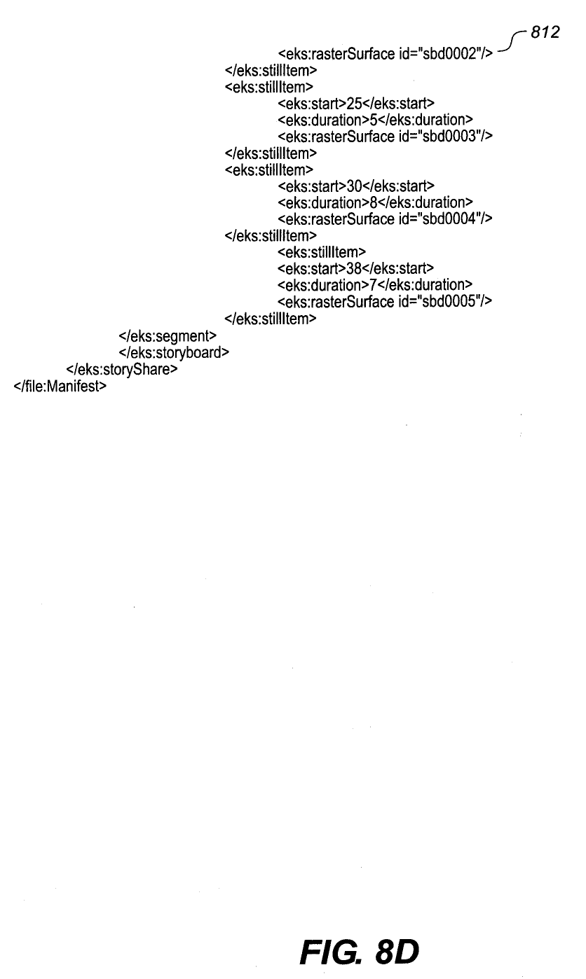

Referring to FIG. 8 there is illustrated an example segment of a storyshare descriptor file defining, in this example, a “slideshow” output format. The XML code begins with Standard Header Information 801 and the assets that will be included in this output product begins at line Asset List 802. The variable information that is populated by the preceding composer module is shown in bold type. Assets that are included in this descriptor file include AASID0001 803 through ASID0005 804, which include MP3 audio files and JPG image files located in a local asset directory. The assets could be located on any of various local system connected storage devices or on network servers such as internet websites. This example slideshow will also display asset artist names 805. Shared assets such as background image assets 806 and an audio file 803 are also included in this slideshow. The storyshare information begins at line Storyshare Section 807. A duration of the audio is defined 808 as 45 seconds. Display of asset ASID0001.jpg 809 is programmed for a display time duration of 5 seconds 810. The next asset ASID0002.jpg 812 is programmed for a display time duration of 15 seconds 811. Various other specifications for the presentation of assets in the slideshow are also included in this example segment of a descriptor file and are well known to those skilled in the art and are not described further.

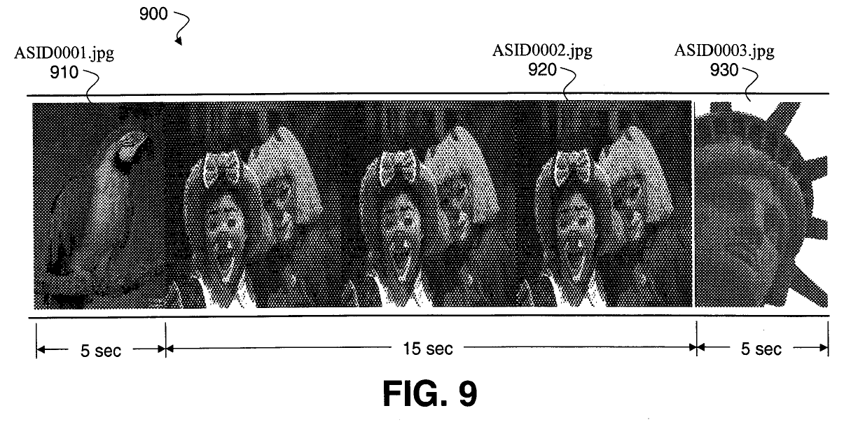

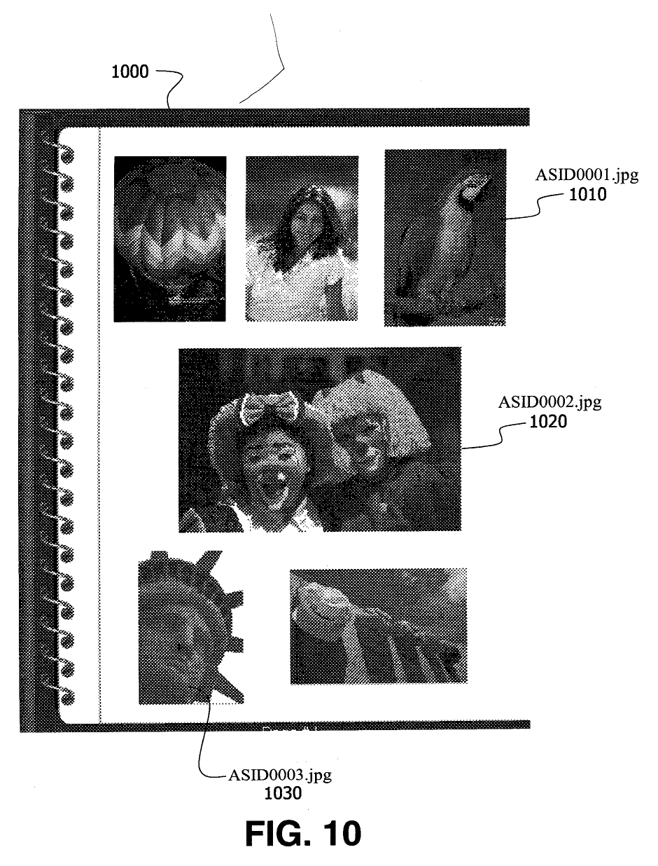

FIG. 9 represents a slideshow output segment 900 of the two assets described above, ASID0001.jpg 910 and ASID0002.jpg 920. Asset ASID0003.jpg 930 has a 5 second display time duration in this slideshow segment. FIG. 10 represents a reuse of the same descriptor file that generated the slideshow of FIG. 9 in a collage output format 1000 from the same storyshare descriptor file illustrated in FIG. 8. The collage output format shows a non-temporal representation of the temporal emphasis, e.g., increased size, given asset ASID0002.jpg 1020 in the slideshow format, since it has a longer duration than the other assets ASID0001.jpg 1010 and ASID0003.jpg 1030. This illustrates the impact of asset duration in two different outputs, a slideshow and a collage.

### ALTERNATIVE EMBODIMENTS

It will be understood that, although specific embodiments of the invention have been described herein for purposes of illustration and explained in detail with particular reference to certain preferred embodiments thereof, numerous modifications and all sorts of variations may be made and can be effected within the spirit of the invention and without departing from the scope of the invention.

Accordingly, the scope of protection of this invention is limited only by the following claims and their equivalents.

### PARTS LIST

6 Digital Camera
10 Computer System
12 Data Bus
14 CPU
16 Read-Only Memory
18 Network Connection Device
20 Hard Disk Drive
22 Random Access Memory
24 Display Interface Device
26 Audio Interface Device
28 Desktop Interface Device
30 CD-R/W Drive
32 DVD Drive
34 USB Interface Device
40 DVD-Based Removable Media Such As DVD R- or DVD R+
42 CD-Based Removable Media Such As CD-ROM or CD-R/W
44 Mouse
46 Keyboard
48 Microphone
50 Speaker
52 Video Display
60 Network
110 Assets
111 Theme Descriptor & Template File
112 Default Storyshare Descriptor File
113 Output Descriptor File
114 Story Composer/Editor Module
115 Composed Storyshare Descriptor File
116 Story Renderer/Viewer Module
117 Story Authoring Module
118 Creates Various Output
200 User Accepts Suggested Theme
210 User Selects Theme
220 Use Metadata to Obtain Theme Specific 3^{rd} Party Assets and Effects
230 User Accepts Theme Specific Assets and Effects?
240 Arranged User Assets+Theme Specific Assets and Effects
250 Obtain Alternative Theme Specific 3^{rd} Party Assets and Effects
260 To Preview Module
270 Arranged User Assets+Theme Specific Assets and Effects
280 User Selects Intended Output Type
290 Output Type Look-Up Table
300 Apply Theme Specific Effects to Arranged User and Theme Specific Assets for Intended Output Type
310 Present User with a Virtual Output Type Draft Including Asset/Output Parameters
320 Asset/Output Look-Up Parameter Table
390 Output Format Look-Up Table
400 Virtual Output Draft
410 Does User Approve?
420 Produce Output Product
430 Deliver Output Product
600 User ID/Profile
610 User Asset Collection
620 Acquire Existing Metadata
630 Extract New Metadata
640 Process Metadata
650 Use Metadata to Organize and Rank Order Assets
660 Automatic Asset Selection?
670 User Asset Selection
680 Can Metadata Suggest a Theme?
690 Theme Look-Up Table
700 XML Code
710 Asset
720 Seconds
730 Asset
800 Slideshow Representation
801 Standard Header Information
802 Asset List
803 “AASID0001”
804 “ASID0005”
805 Asset Artist Name
806 Background Image Assets
807 Storyshare Section
808 Duration of an Audio
809 Display of Asset ASID0001.jpg
810 Asset
811 Display Time Duration of 15 Seconds
812 Asset ASID0002.jpg
820 Asset
830 Asset
900 Collage Representation
910 Asset
920 Asset
930 Asset
1000 collage output format
1010 ASID0001.jpg
1020 ASID0002.jpg
1030 ASID0003.jpg

What is claimed is:

1. A computer implemented method for automatically selecting some multimedia assets from a plurality of multimedia assets stored on a computer system, comprising the steps of:
reading input metadata associated with said plurality of assets;
generating derived metadata based on the input metadata, including storing the derived metadata;
ranking the plurality of assets based on the assets' input metadata and derived metadata; and
automatically selecting a subset of the plurality of assets based on the ranking of the plurality of assets.

2. The method of claim 1 further comprising the step of obtaining and storing user profile information including user preference information, and wherein the step of ranking further includes the step of ranking the plurality of assets based on the user profile information.

3. The method according to claim 1, wherein the multimedia assets are digital assets selected from pictures, still images, text, graphics, music, video, audio, multimedia presentation, or a descriptor file.

4. The method according to claim 1, wherein the input metadata comprises input metadata tags.

5. The method according to claim 1, wherein the derived metadata comprises derived metadata tags.

6. A computer implemented method for generating story themes based on a plurality of multimedia assets stored on a computer system, comprising the steps of:
reading input metadata associated with said plurality of assets;
generating derived metadata based on the input metadata, including storing the derived metadata;
providing a theme lookup table that includes a plurality of themes each having associated attributes, including accessing the theme lookup table; and
comparing the input and derived metadata with said theme look up table attributes to identify themes having substantial similarity with the input and derived metadata.

7. The method according to claim 6, wherein said theme look up table includes attributes selected from birthday, anniversary, vacation, holiday, family, or sports.

8. The method according to claim 6, wherein the multimedia assets are digital assets selected from pictures, still images, text, graphics, music, video, audio, multimedia presentation, or a descriptor file.

9. The method according to claim 6, wherein the input metadata comprises input metadata tags.

10. The method according to claim 6, wherein the derived metadata comprises derived metadata tags.

11. A computer implemented method of generating a story comprising a plurality of multimedia assets stored on a computer system, comprising the steps of:
reading input metadata associated with said plurality of assets;
generating derived metadata based on the input metadata, including storing the derived metadata;
providing a theme lookup table that includes a plurality of themes each having associated attributes, including accessing the theme lookup table;
comparing the input and derived metadata with said theme look up table including selecting a theme;
providing a plurality of programmable effects applicable to the plurality of assets;
providing a rules database for constraining an application of an effect upon an asset based on its metadata; and
assembling the plurality of assets into a storyshare descriptor file based on a selected theme, the plurality of assets, and on the rules database.

12. The method according to claim 11, wherein a zoom effect applied to an asset is constrained according to the asset's metadata and the rules database.

13. The method according to claim 11, wherein an image-processing algorithm applied to an asset is constrained according to the asset's metadata and the rules database.

14. The method according to claim 11, wherein the step of providing a theme lookup includes the step of retrieving a third party theme lookup table from a local storage device connected to the computer system.

15. The method according to claim 11, wherein the step of providing a theme lookup includes the step of retrieving a third party theme lookup table over a network from another computer system.

16. The method according to claim 11, wherein the multimedia assets are digital assets selected from pictures, still images, text, graphics, music, video, audio, multimedia presentation, or a descriptor file.

17. The method according to claim 11, wherein the step of providing a plurality of programmable effects includes the step of retrieving third party programmable effects from a local storage device connected to the computer system.

18. The method according to claim 11, wherein the derived metadata comprises derived metadata tags.

19. The method according to claim 11, wherein the step of providing a plurality of programmable effects includes the step of retrieving third party programmable effects over a network from another computer system.

20. The method according to claim 19, wherein the third party themes and effects are selected from dynamic auto-scaling image templates, automatic image layout algorithms, video scene transitions, scrolling titles, graphics, text, poetry, audio, music, songs, digital motion and still images of celebrities, popular figures, or cartoon characters.

21. A system for composing a story comprising:
a plurality of multimedia assets accessible by a computer;
a component for extracting metadata associated with the plurality of assets and for generating derived metadata;
a theme descriptor file including effects applicable to the plurality of assets and thematic templates for presenting the plurality of assets;
a rules database comprising conditions for limiting an application of effects to those of the assets that meet the conditions of the rules database; and
a component for assembling the plurality of assets based on the conditions of the rules database into a storyshare descriptor file.

22. The system according to claim 21, wherein the multimedia assets are digital assets selected from pictures, still images, text, graphics, music, video, audio, multimedia presentation, or a descriptor file.

23. The system according to claim 21, wherein said theme descriptor file comprises data selected from location information, background information, special effects, transitions, or music.

24. The system according to claim 21, wherein said storyshare descriptor file is in XML format.

25. A program storage device readable by computer, tangibly embodying a program of instructions executable by the computer to perform the method steps of claim 1.
